(19) United States
(12) Patent Application Publication
(10) Pub. No.: US 2015/0302524 A1
(43) Pub. Date: Oct. 22, 2015

(54) Method and System for Generating Compliance Data

(71) Applicant: UNIVERIS CORPORATION, Toronto (CA)

(72) Inventors: Craig ALLISON, Toronto (CA); Richard BINNENDYK, Toronto (CA)

(21) Appl. No.: 14/648,710

(22) PCT Filed: Nov. 29, 2013
(86) PCT No.: PCT/CA2013/050918

§ 371 Date: May 31, 2015

Related U.S. Application Data
(63) Continuation of application No. 13/774,482, filed on Feb. 22, 2013.
(60) Provisional application No. 61/731,579, filed on Nov. 30, 2012.

(30) Foreign Application Priority Data
Feb. 22, 2013 (CA) 2807132

(51) Int. Cl. G06Q 40/06

(52) U.S. Cl. CPC G06Q 40/06

(57) ABSTRACT

A computer implemented method for generating financial compliance data including generating by a computer system a risk tolerance questionnaire receiving data inputted by a user and stored in a first database on a computer readable medium in communication with the computer system; the risk tolerance questionnaire including data fields representative of a user's financial risk tolerance; generating by the computer system a know-your-client user profile stored in a second database on a computer readable medium in communication with the computer system; and mapping one or more fields from the first database onto one or more fields from the second database, such that the know-your-client user profile is at least partially completed with data obtained from the risk tolerance questionnaire.

### FIELD OF THE INVENTION

The present invention relates generally to financial planning. In particular, the invention relates to a method and system for generating compliance data.

### BACKGROUND OF THE INVENTION

Currently, client risk profiles are used as sales tools designed to sell investment products. The process of profiling a client's risk tolerance for a sales purpose is distinct from the process of profiling a client's risk tolerance for compliance purposes. The know-your-client/customer (“KYC”) process is an industry standard for financial industry compliance. Yet, there are no mechanisms or processes in place for justifying KYC inputs. Advisors are required to complete two processes: one for the portfolio recommendation and a second for the compliance function. Compliance is traditionally a separate, after-sales process. Once the client risk tolerance has been determined and a portfolio recommendation has been made, compliance (KYC) data is then generated. There is no documentation on file demonstrating how the advisor derived the KYC inputs used for compliance purposes. KYC inputs are derived through a discovery session/discussion that takes place between advisors and investors. Advisors make assessments based on client comments but retain no or relative informal records of how this assessment was made. This lack of documentation leads to litigation risk for investment dealers.

In addition, this lack of documentations results in data security issues since an assessment that belongs to a bank or other financial institution is retained primarily with an individual advisor. There is thereby limited continuity in the event there is a required change in advisors.

It is therefore an object of the invention to provide a novel method and system for generating compliance data.

### SUMMARY OF THE INVENTION

According to one embodiment of the invention, there is provided a computer implemented method for generating financial compliance data including generating by a computer system a risk tolerance questionnaire receiving data inputted by a user and stored in a first database on a computer readable medium in communication with the computer system; the risk tolerance questionnaire including data fields representative of a user's financial risk tolerance; generating by the computer system a know-your-client user profile stored in a second database on a computer readable medium in communication with the computer system; and, mapping one or more fields from the first database onto one or more fields from the second database, such that the know-your-client user profile is at least partially completed with data obtained from the risk tolerance questionnaire.

According to one aspect of the invention, the risk tolerance questionnaire includes open-ended and close-ended questions; the method further including the step of periodically prompting a user to provide updated responses to the open-ended questions.

According to another aspect of the invention, the method further includes determining by the computer system a financial portfolio recommendation for the user and presenting the financial portfolio recommendation to the user.

According to another aspect of the invention, the know-you-client user profile includes data fields including one or more of client age, investment knowledge, income, net worth, financial objective, investment horizon and risk aversion.

According to another aspect of the invention, the one or more fields mapped from the first database onto the second database include at least one score field; wherein the score field is stored on the second database and mapped from a field on the first database.

According to another aspect of the invention, the method further includes comprising storing the risk tolerance questionnaire in an archive database and subsequently creating a new risk tolerance questionnaire at least partially populated by the risk tolerance questionnaire in the archive database.

According to another aspect of the invention, the method further includes further comprising providing by the computer system an alert to a user to update the risk tolerance questionnaire.

According to another embodiment of the invention, there is provided a system for generating financial compliance data including computer readable instructions stored on a computer readable medium that when executed by a computer system generates a risk tolerance questionnaire receiving data inputted by a user and stored in a first database on a computer readable medium in communication with the computer system; the risk tolerance questionnaire including data fields representative of a user's financial risk tolerance; computer readable instructions stored on a computer readable medium that when executed by a computer system generates a know-your-client user profile stored in a second database on a computer readable medium in communication with the computer system; computer readable instructions stored on a computer readable medium that when executed by a computer system maps one or more fields from the first database onto one or more fields from the second database, such that the know-your-client user profile is at least partially completed with data obtained from the risk tolerance questionnaire.

### BRIEF DESCRIPTION OF THE DRAWINGS

An embodiment will now be described, by way of example only, with reference to the attached Figures, wherein:

FIG. 1 shows the current state-of-the-art approach to recommending a portfolio versus the approach used by a computer system in accordance with an embodiment of the invention;

FIG. 2 shows the estimation of the total annual cost of portfolio suitability—related complaints;

FIG. 3 shows various inputs that are used to generate KYC variables that are used to generate a portfolio recommendation;

FIG. 4 shows various physical elements of a computer system 20 for generating compliance data in accordance with an embodiment of the invention;

FIG. 5 shows the configuration and use workflows for the computer system of FIG. 4;

FIG. 6 shows the general method of configuring the computer system of FIG. 4;

FIG. 7 shows the generation of compliance data using the computer system of FIG. 4;

FIGS. 8A to 8H show the mapping of a risk tolerance questionnaire responses to KYC variables using the computer system of FIG. 4;

FIGS. 9A to 9M show various risk tolerance questionnaire screens.

### DETAILED DESCRIPTION OF THE EMBODIMENTS

A computer system for generating compliance data in accordance with an embodiment of the invention enables the design of questionnaires that complete the client KYC and recommends a model portfolio. The scoring and questionnaire content are completely customizable. An Investment Policy Statement is generated as output by the process. Investment portfolios designed by financial advisors and by investment product vendors can be then provided as recommendations. The risk tolerance questionnaire responses and the associated KYC variables are time-stamped and stored by the system for future reference.

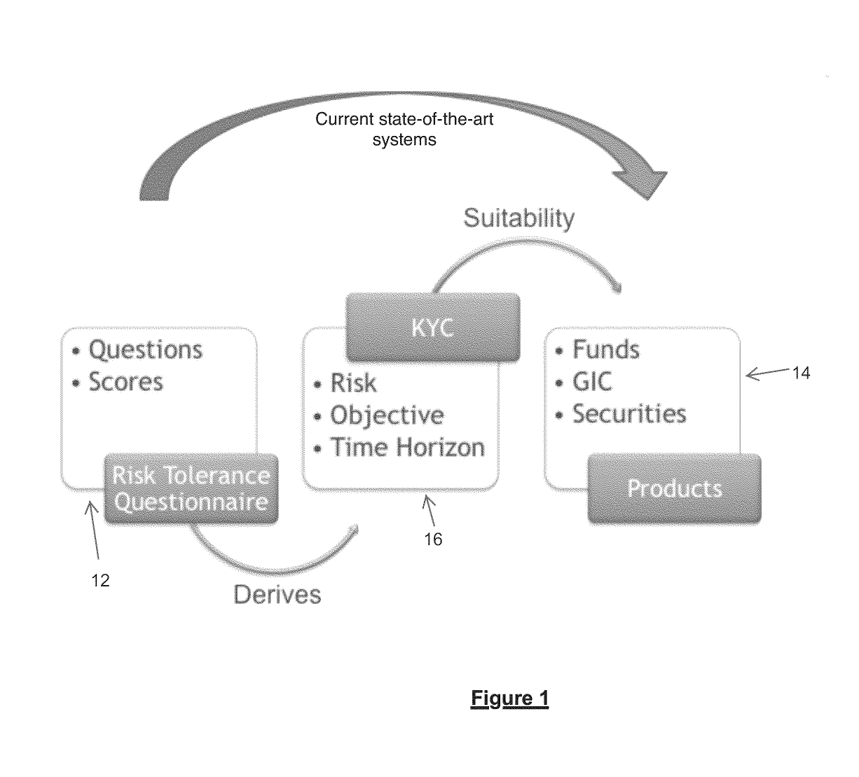

FIG. 1 shows that current state-of-the-art systems where responses are received at step 12 from a risk tolerance questionnaire (RTQ), which responses are then considered and analyzed by an investment advisor to generate an investment recommendation at step 14 based on the risk tolerance questionnaire responses. Know-Your-Client (KYC) data is then separately derived at step 16, which stores information such as a client risk profile, investment objectives and investment time horizon. The present computer system and method according to the invention, first uses the risk tolerance questionnaire responses to derive KYC variables. The risk tolerance questionnaire responses and the KYC variables are then used in combination to generate a portfolio recommendation. Details of implementation and other benefits of the invention will become evident to a person skilled in the art in view of the description below.

The risk tolerance questionnaire preferably includes a combination of closed and open-ended questions. Open-ended questions are defined as those that are flagged, or otherwise indicated to be revisited intermittently and preferably on a predetermined scheduled. More specifically, open-ended questions have responses that can change over time, and therefore in this manner, the KYC data can be revisited regularly to ensure that the investment portfolio is appropriate for the risk tolerance. A client's risk tolerance can change over time for a number of reasons. A person may age significantly since originally completing the risk tolerance questionnaire, thus making their risk tolerance decrease in most cases. A client may experience life changes, such as marriage, or make decisions that can impact their risk tolerance, such as changing their target retirement age. Other reasons for changes in a person's risk tolerance may be known in the art. Thus, it is of interest to revisit some questions in the risk tolerance questionnaire to determine if the client's risk tolerance has changed. Preferably though, not all questions should be revisited on a regular schedule to save both time and computing resources.

Investment dealers have identified a key risk in their business as the ability to prove the validity of client KYC information, specifically how did advisors arrive at client risk and objective (KYC attributes).

The reason for this being a risk include one or more of the following:
1. Client complaints being received by dealers, questioning the allocation of their investments against their risk and objective. This includes complaints from clients against advisors that have left or were terminated from dealer (this being the most expensive complaint to settle)
2. Regulatory response to suitability complaints is to lead investor to question how KYC was derived.
3. Internal and regulatory audit results that highlight lack of proof in how advisors determine client risk and objectives.

The specific risks identified are:
Profitability Risk: High cost of complaint management reduces profits and exposes the firm to potentially large dollar complaints.
Compliance Risk: Risk of regulatory defect given no proof of how KYC attributes were assigned.
Brand Risk: Risk of reputation to the organization of complaints being made public.

The risk that exists within current processes is the lack of proof or documentation that shows regulators how the client's key KYC attributes were determined. This lack of proof is subsequently highlighted in investigation of client complaints about the suitability of their investments, resulting in significant costs to dealers to investigate and settle the complaints.

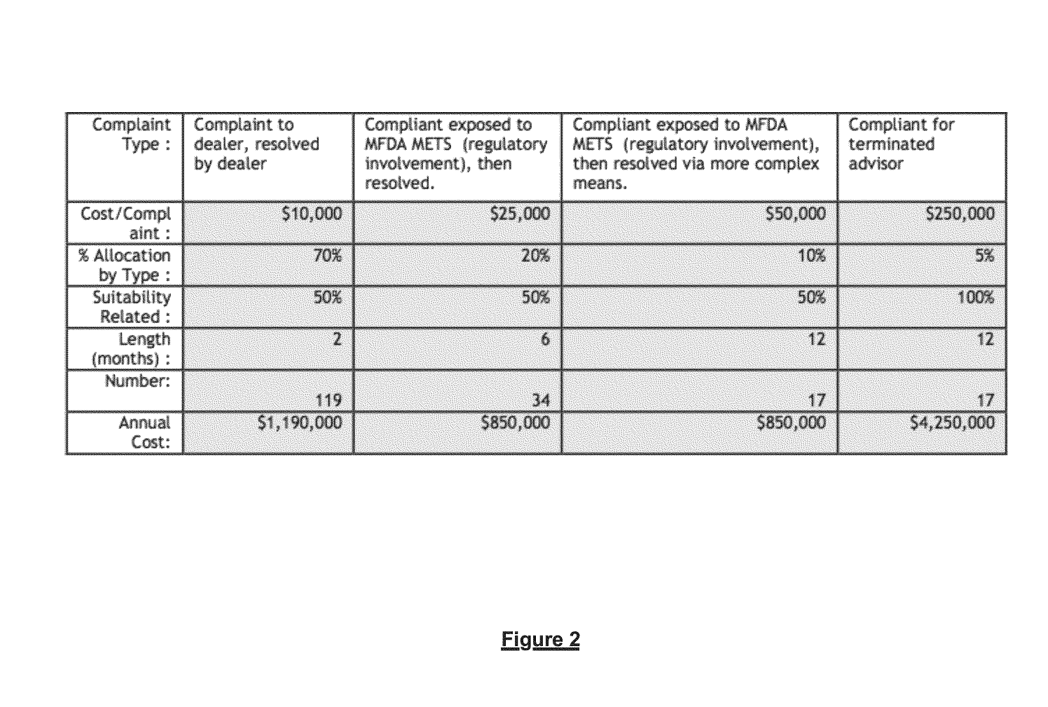

FIG. 2 shows the estimation of the total annual cost of portfolio suitability—related complaints for all clients of the applicant. Annual complaints amount to approximately 0.02% of all investors. With two million investors/clients, this amounts to 500 complaints annually. The cost to dealers of this risk is significant. Complaints by investors can be categorized as shown in FIG. 2. The annual cost of suitability-related complaints to this group of investment dealers is therefore approximately $7,140,000.

For financial advisors, no standard Risk Tolerance Questionnaire (RTQ) is provided. Some advisors use risk tolerance questionnaires with model portfolios. Existing RTQ's have the following features:
1. A questionnaire that uses a scoring system to lead to an asset model (1 of 6)
2. Portfolio models recommended based on a client's response to the RTQ

The process supported by these risk tolerance questionnaires is:
1. Questionnaire→Asset Allocation→Investment Policy Statement→Model for execution.
2. RTQ can also serve to lead the discussion between advisor and investor.

While these RTQ's have beneficial applications in many cases, there are some significant issues with it that prevents it from being used to solve the issues currently being faced by dealers:
1. RTQ's do not contribute to deriving a client's KYC, thus providing no proof of how these KYC attributes were derived.
2. The scoring system is not compliant with MFDA guidelines provided in MR-0069.
3. Questionnaires are fixed, requiring development resources to modify if required.
4. Questionnaires are standalone processes, requiring duplication of effort by advisors/administrators to execute on the product recommendations provided.
5. These solutions do not enable audits of previously completed questionnaires for easy retrieval and referral.

Any discussion of an RTQ solution should ensure that such a solution conforms to MFDA, or analogous, guidelines regarding the use of questionnaires to determine client KYC attributes. These guidelines are typically set by regulatory bodies in various jurisdictions.

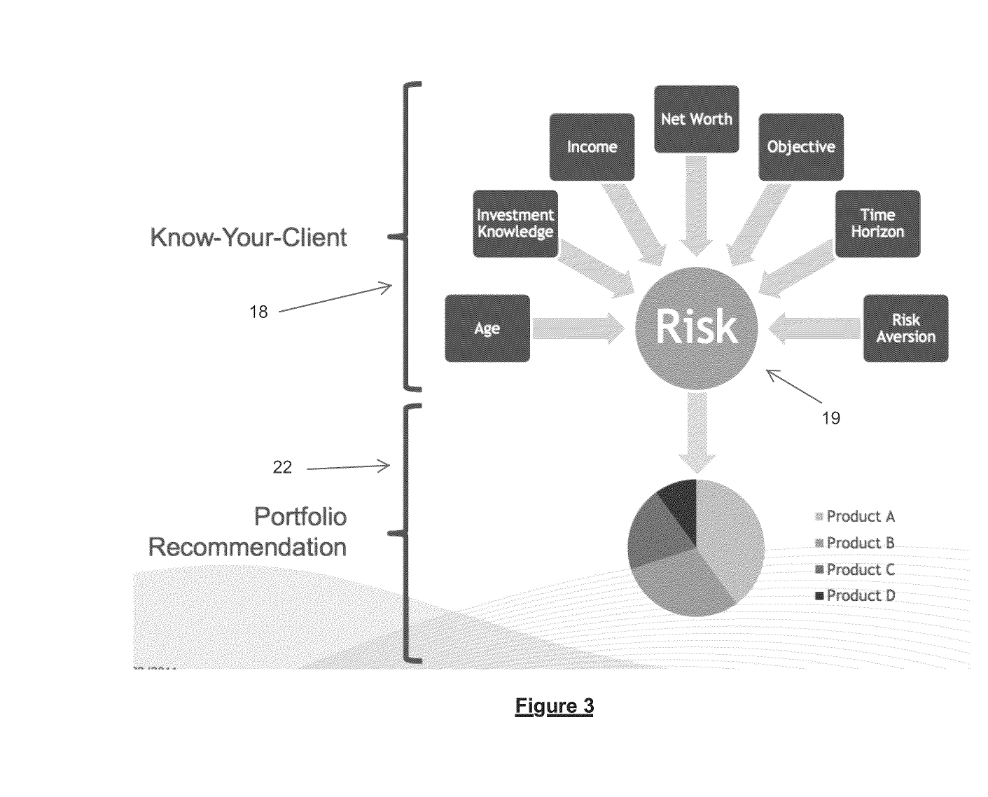

As shown in FIG. 3, various inputs may be used to generate KYC variables 18 that are then used to generate a portfolio recommendation 22. The KYC variables 18 may include age, investment knowledge, income, net worth, financial objective, time horizon and risk aversion. Each of these is used in determining a risk profile 19, which is used to create a portfolio recommendation 22.

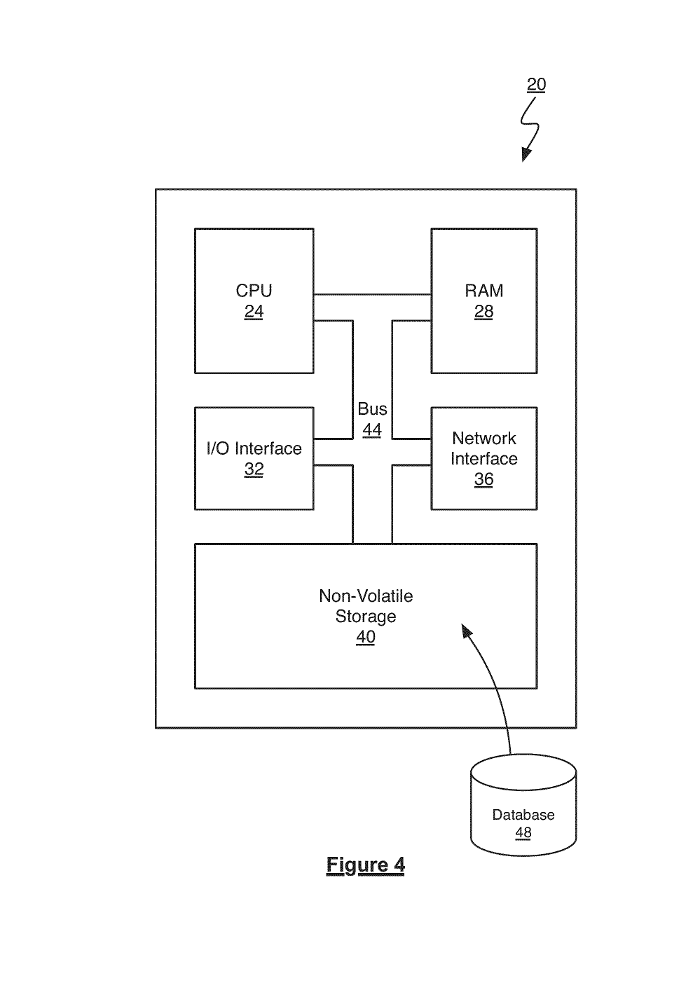

FIG. 4 shows various physical and logical elements of a computer system 20 for generating compliance data. As shown, the computer system 20 has a number of physical and logical components, including a central processing unit (“CPU”) 24, random access memory (“RAM”) 28, an input/output (“I/O”) interface 32, a network interface 36, non-volatile storage 40, and a local bus 44 enabling the CPU 24 to communicate with the other components. The CPU 24 executes an operating system and a financial planning application. RAM 28 provides relatively-responsive volatile storage to the CPU 24. The I/O interface 32 allows for input to be received from one or more devices, such as a keyboard, a mouse, etc., and outputs information to output devices, such as a display and/or speakers. The network interface 36 permits communication with other systems. Non-volatile storage 40 stores the operating system and programs, including computer-executable instructions for implementing the financial planning application, and the financial planning application's data. During operation of the computer system 20, the operating system, the programs and the data may be retrieved from the non-volatile storage 40 and placed in RAM 28 to facilitate execution.

The computer system 20 stores a client database 48 in non-volatile storage 40. The client database 48 stores client profiles. Each client profile includes client personal data, historical risk tolerance questionnaire responses, historical derived KYC variables, and historical proposed investment strategies. The client personal data may include name, social security number, address, telephone number, financial account information, etc. The historical risk tolerance questionnaire responses, as well as the historical KYC variables and the historical proposed investment strategies that are derived from the historical risk tolerance questionnaire responses, are registered each time a client completes a risk tolerance questionnaire.

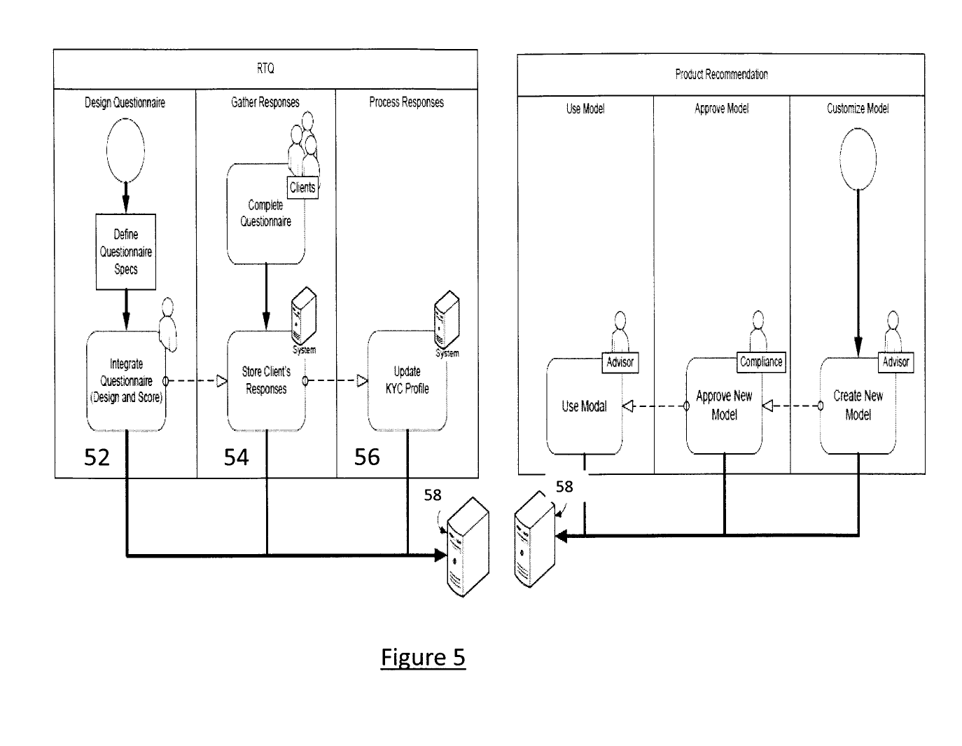

FIG. 5 shows the configuration and use workflow for the computer system of FIG. 4. A risk tolerance questionnaire (RTQ) is designed at step 52, from which responses are gathered at step 54, and processed at step 56. As shown, the RTQ is designed using a computer system. Clients complete the questionnaire, and the responses at step 54 are gathered by a computer system. The computer system then processes the responses to update the KYC profile. The product recommendation side of FIG. 5 is mainly carried out by a financial advisor and compliance officer, and is not described in further detail herein, except insofar as the product recommendation model is entered into a computer system 58 which generates an output based on the KYC profile.

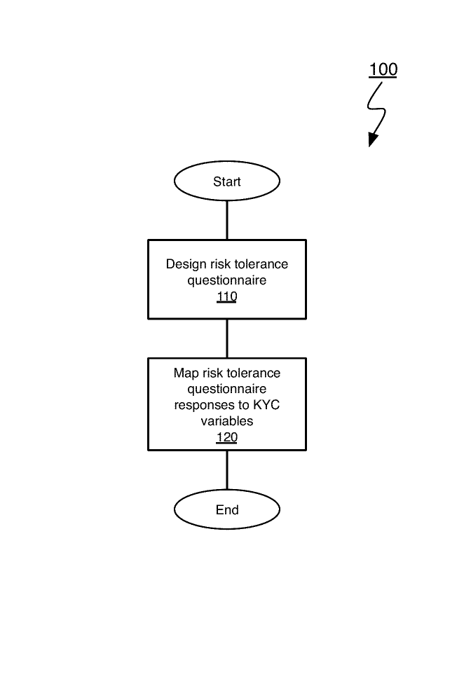

FIG. 6 shows the general method 100 of configuring the computer system 20 for generating compliance data. The method 100 begins with the designing of a risk tolerance questionnaire 110. The risk tolerance questionnaire responses are then mapped to KYC variables 120.

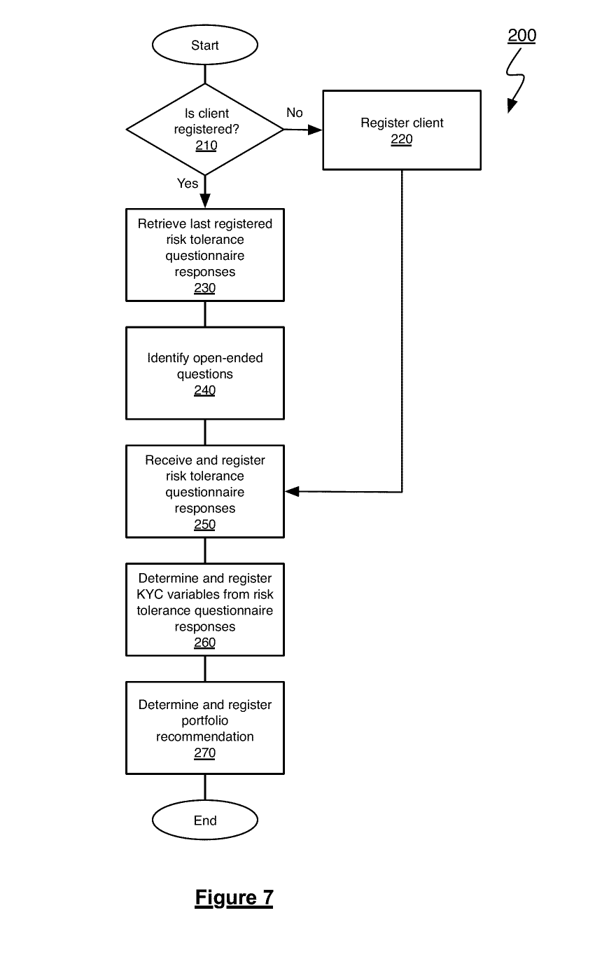

FIG. 7 shows the general method 200 of registering compliance data used by the computer system 20. When a client is to use the computer system 20, it is determined if the client is registered with the computer system 20. If the client is not registered, the client is then registered 220. During registration, the client provides client personal data, as well as information about any financial accounts that the client has.

If the client is already registered with the computer system 20, the client's last registered risk tolerance questionnaire responses are retrieved as a starting point for the client 230. This facilitates completion of the risk tolerance questionnaire by the client. Next, open-ended questions are identified in the risk-tolerance questionnaire 240. Open-ended questions are ones that are to be revisited regularly. If the time passed since last revisiting an open-ended question is greater than the revisiting period specified for that question, the question may be flagged for revisiting. Next, the computer system 20 receives and registers the client's risk tolerance questionnaire responses 250. The client completes the risk tolerance questionnaire and all of the client's responses are registered in the client database 48. Next, KYC variables are determined and registered from the risk tolerance questionnaire responses provided by the client 260. The risk tolerance questionnaire responses provided by the client at 250 are used to calculate the KYC variables using the mappings provided at 120 of method 100. Once the KYC variables have been determined and registered for the client, a portfolio recommendation is determined for the client and registered (270).

The general method 200 may be triggered by the passage of time according to the frequency for the open-ended questions. An alert may be triggered for a financial advisor to follow up with the client regarding the open-ended questions.

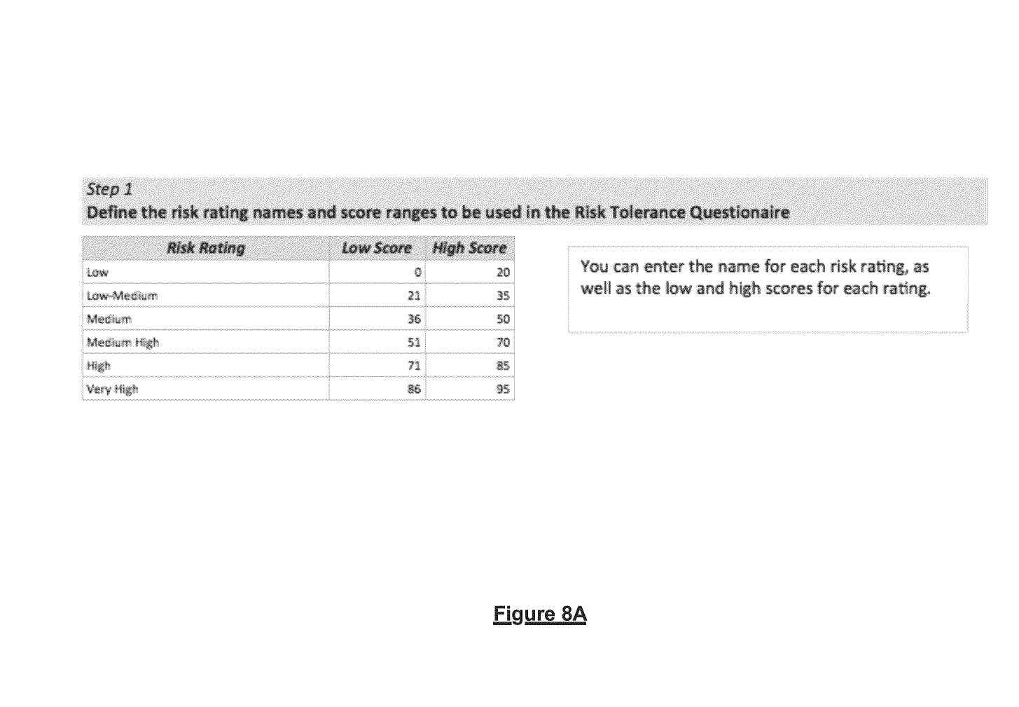

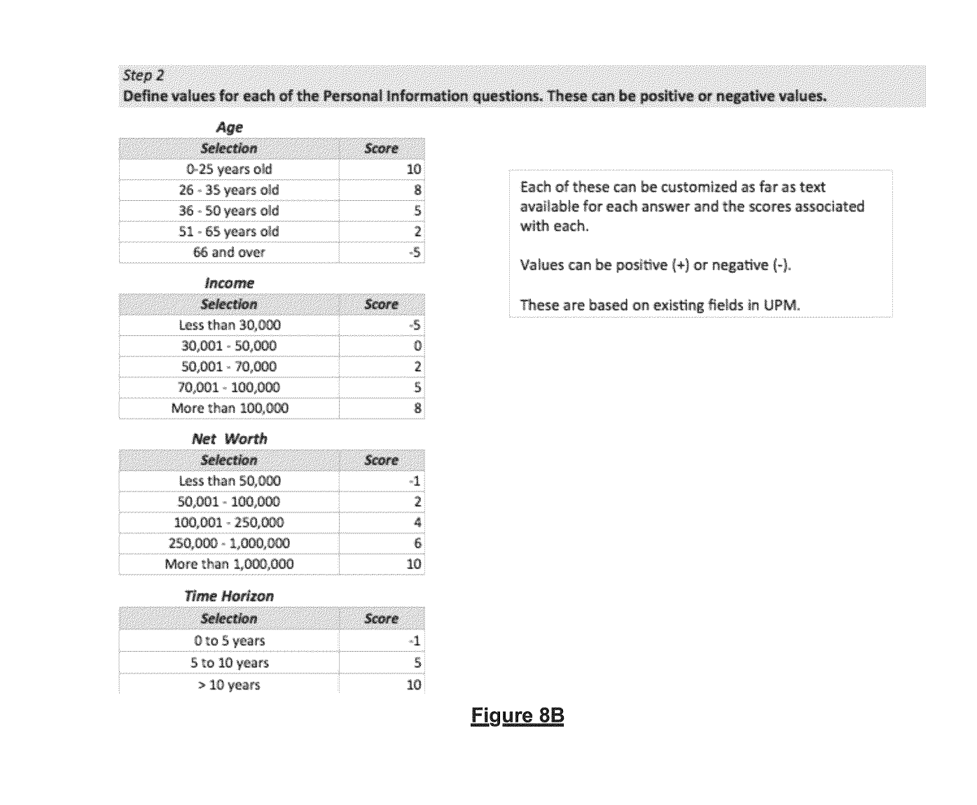

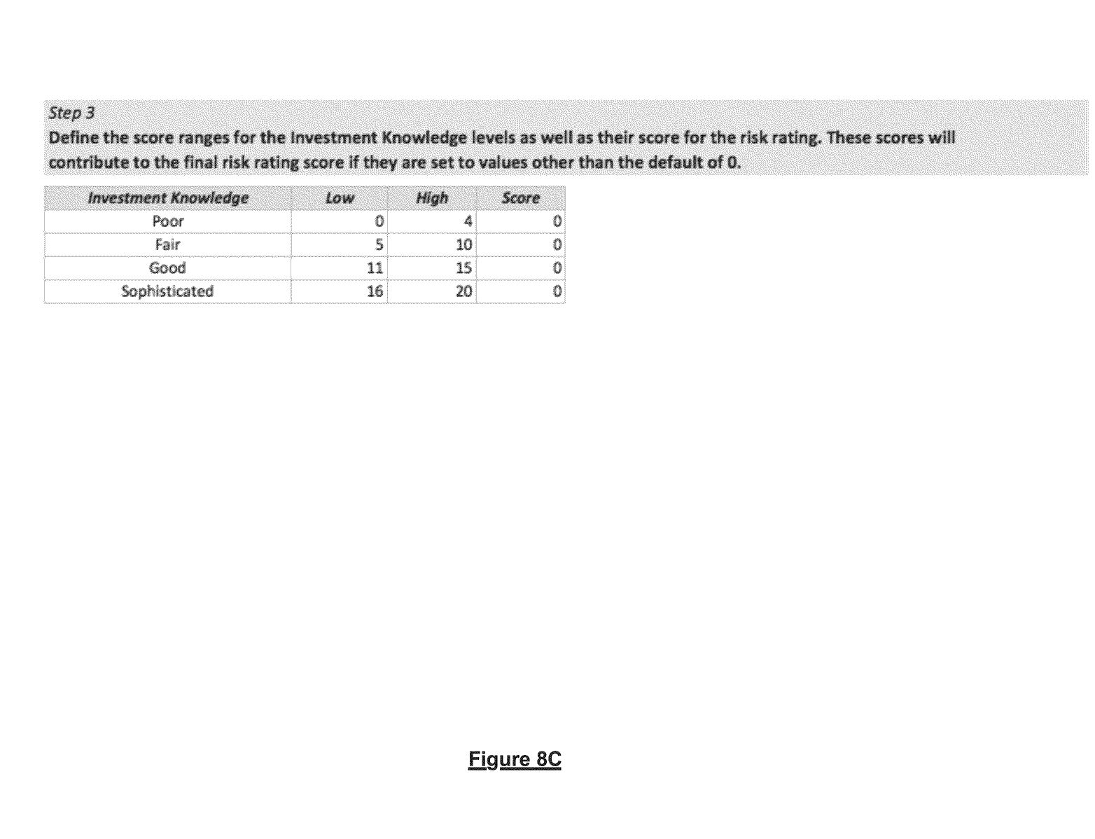

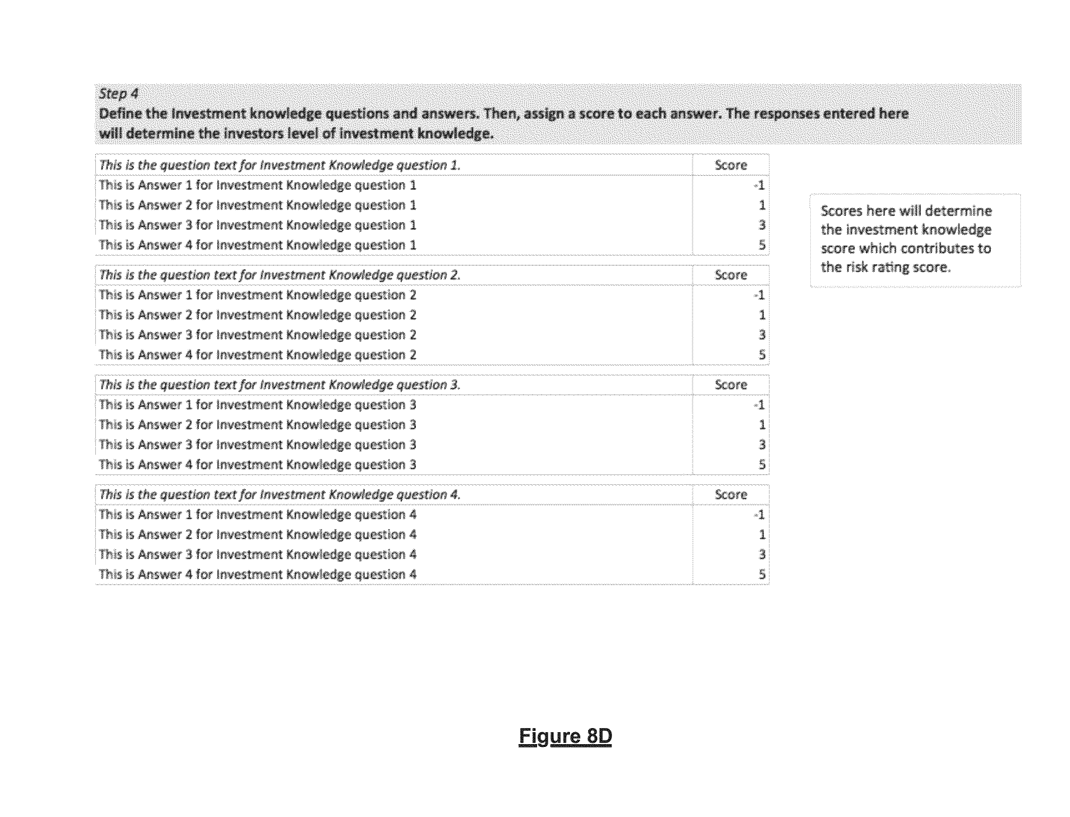

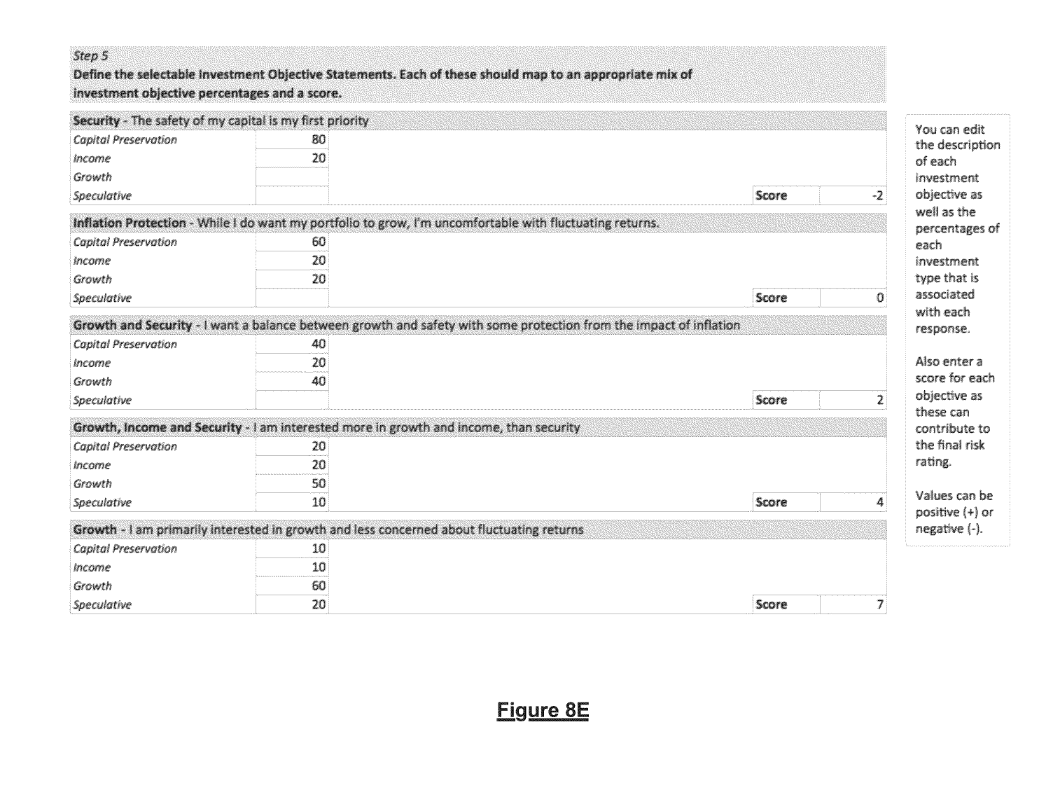

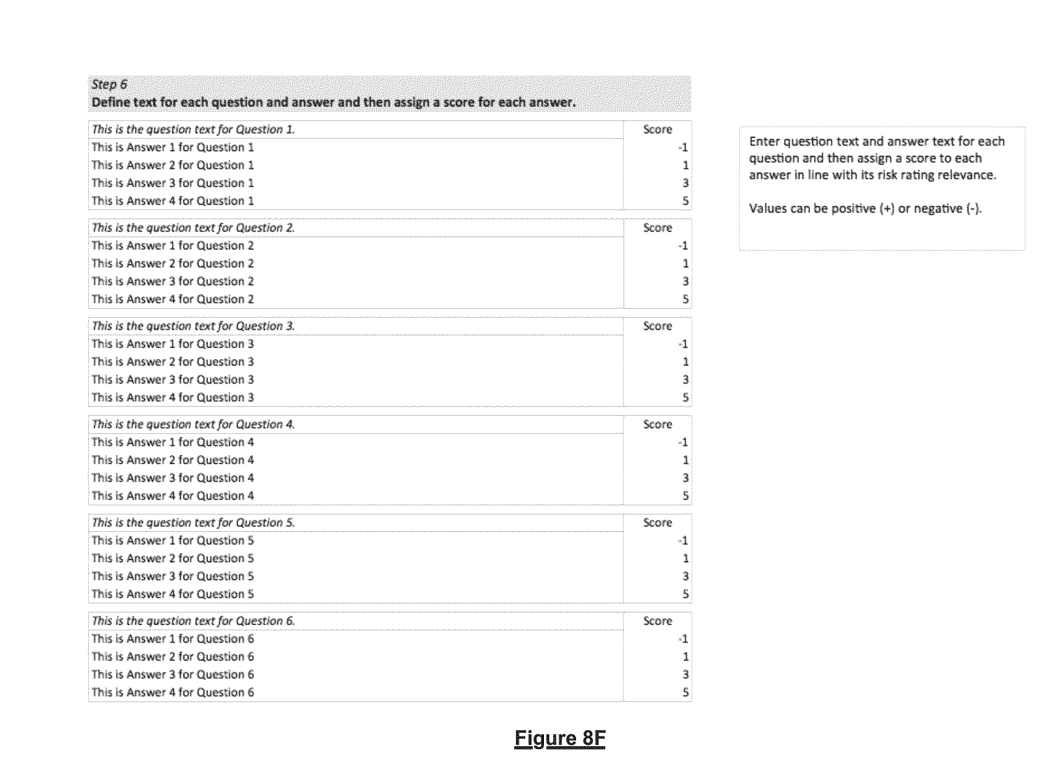

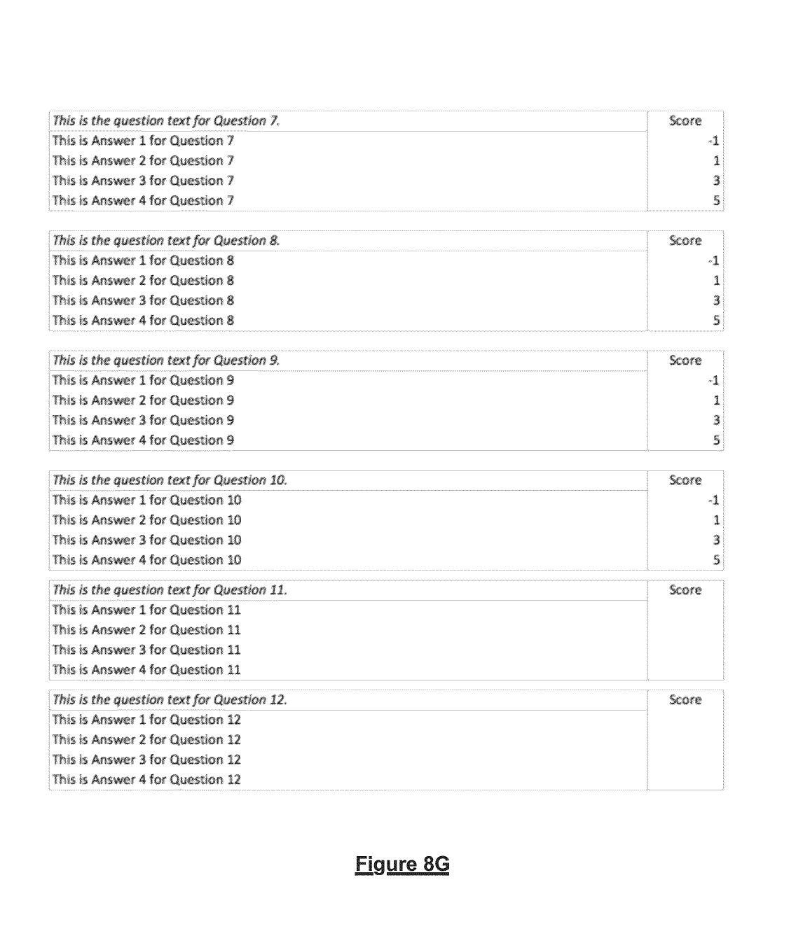

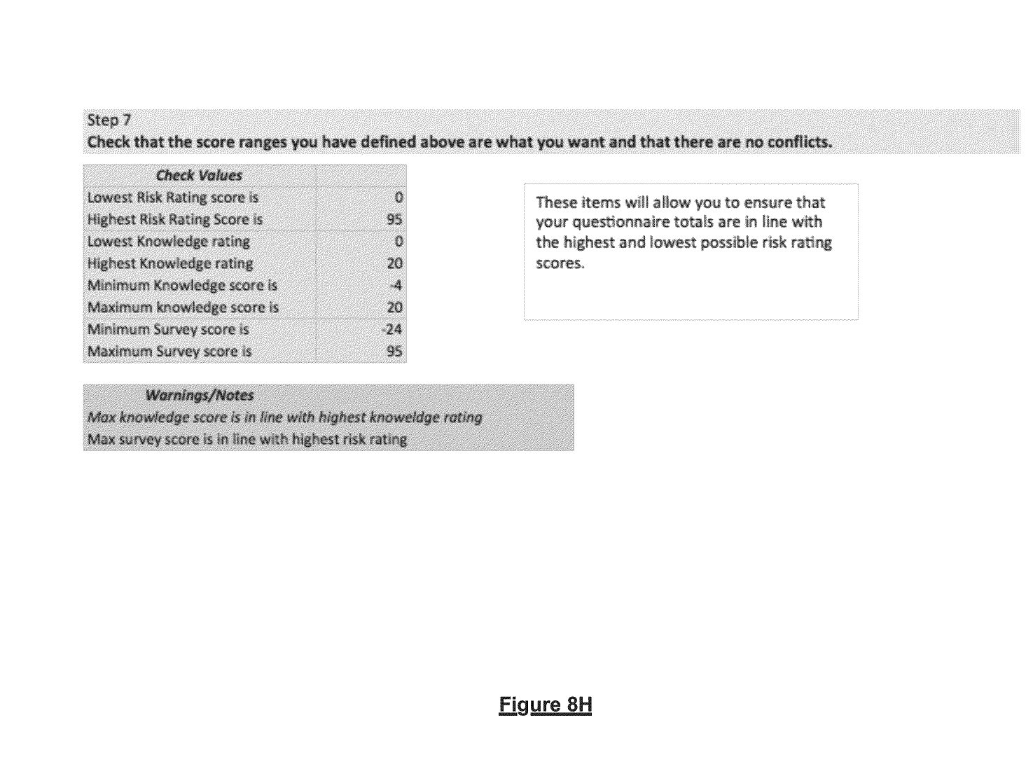

Various features may also be implemented in the method and system as described above which provide clearly identifiable advantages over the prior art. In one embodiment, the framework for creating an RTQ includes questions, answers, scoring for answers and a categorization of the questions and answers to alight with the KYC variables. That is, variables are handled simultaneously for the RTQ and for the KYC aspects of the invention. This permits control of the RTQ content within the financial system, and provides for changes to the RTQ to be easily managed and quickly deployed. The scoring system used by the RTQ derives key client KYC attributes. In particular, these may include risk tolerance, investment objectives and time horizon. A representative scoring system is shown in FIGS. 8A-8H. Applying this methodology reduces investment dealer risk by providing proof and diligence in how both the KYC data and the financial product recommendation were reached. This also provides an automated process saving investment advisors time, and results in a consistent approach applied between clients.

Next, by enforcing the combination of the RTQ and KYC data intake from a centralized computer system, enforcement of the RTQ is enabled, so that both the RTQ and the KYC aspects of the financial system must be completed before a product recommendation is made. A historical audit of RTQ and KYC outcomes are also saved in the client profile, thereby providing proof of process that reduces complaints and allows complaints to be resolved at a lower cost. Preferably, custom models may be created dependent upon the assignment of risk category. In this way, models can be filtered based on the KYC risk. New models may be proposed by financial advisors, and require approval by a system administrator, before implementation into the system of the invention. This allows for controlled changes to the models that ensures stability and long term efficiency of the financial planning system.

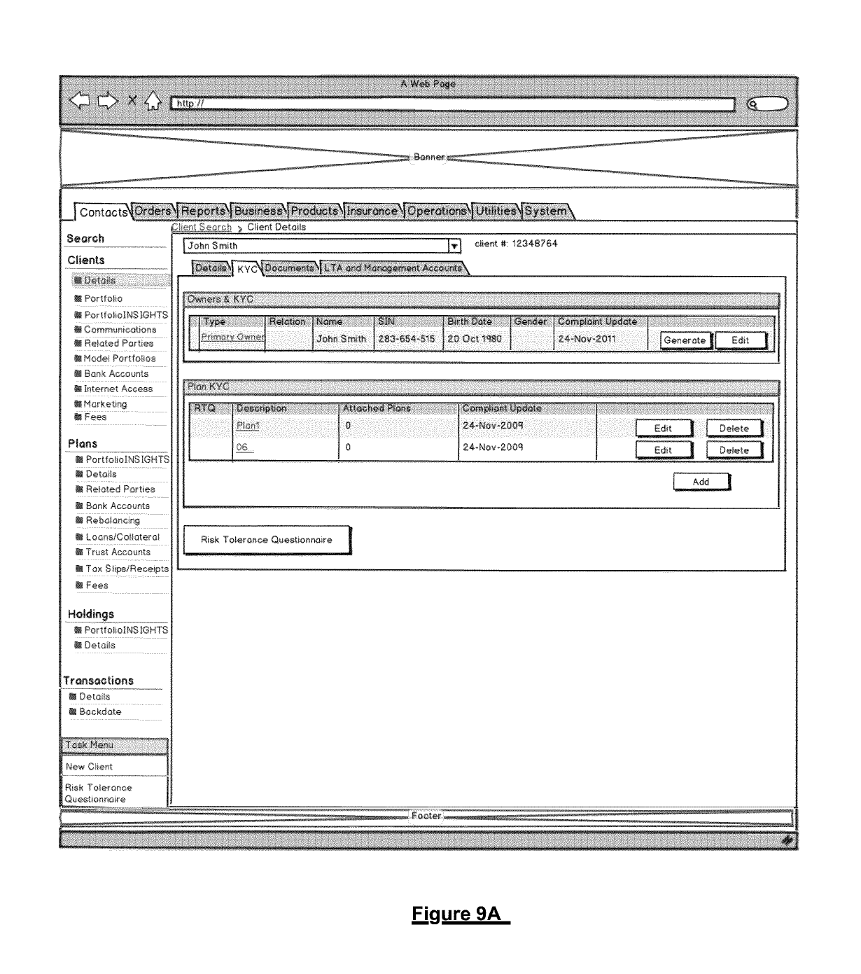

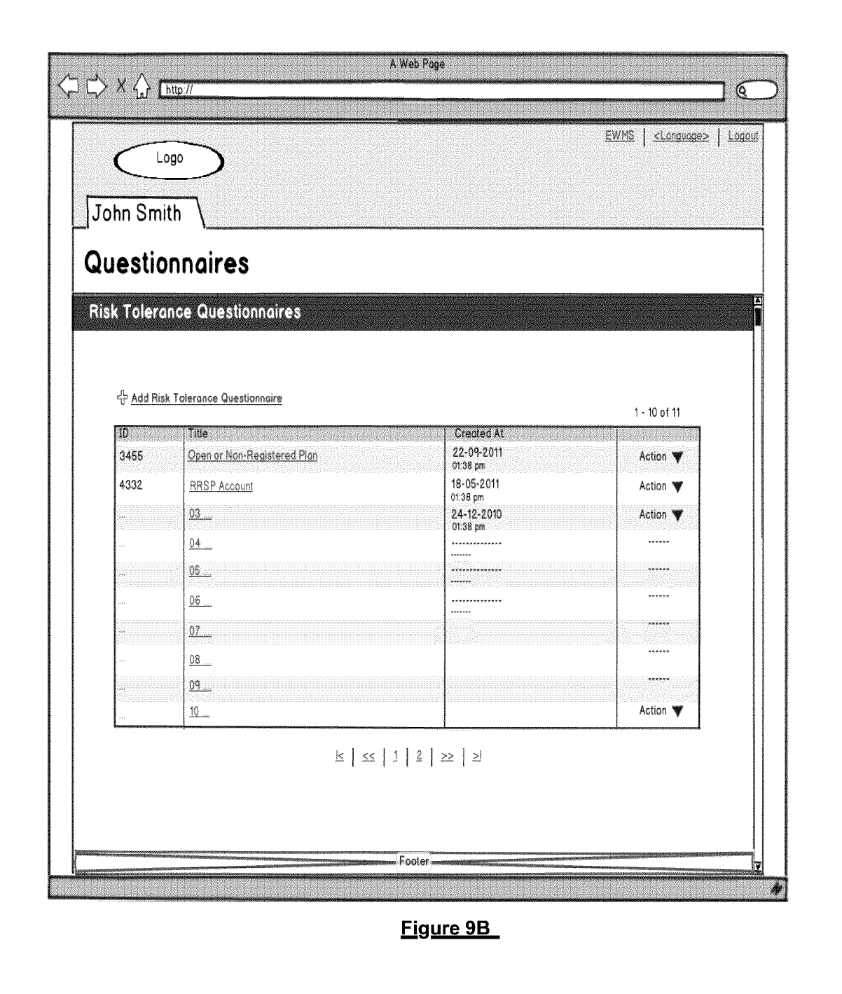

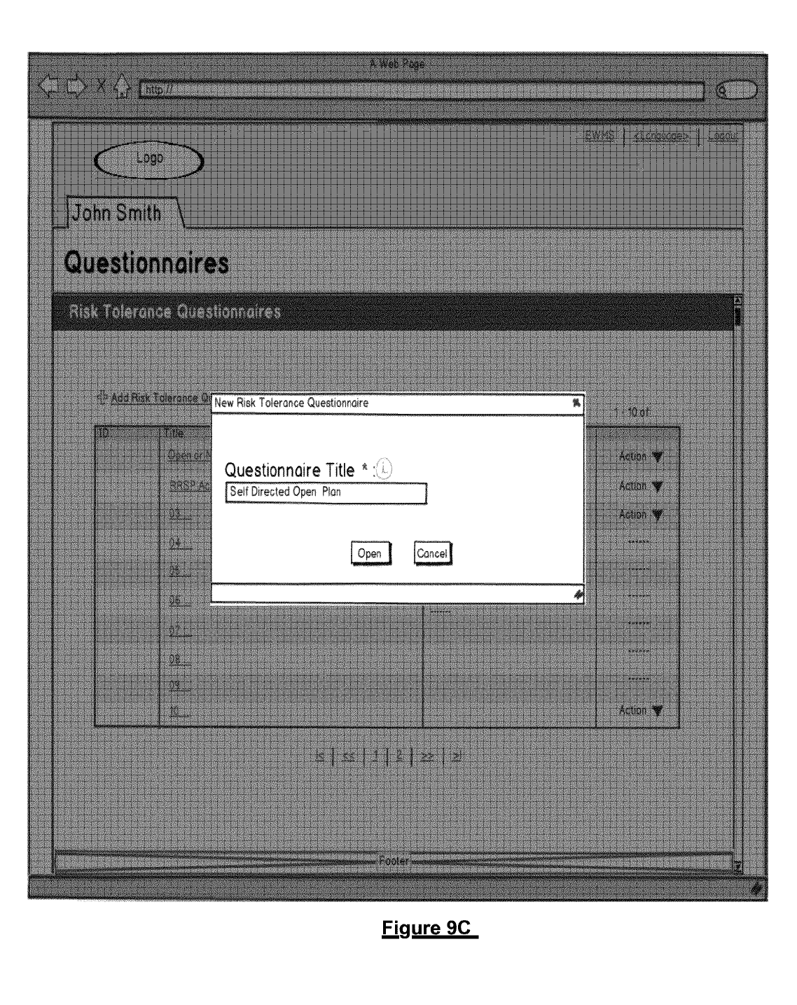

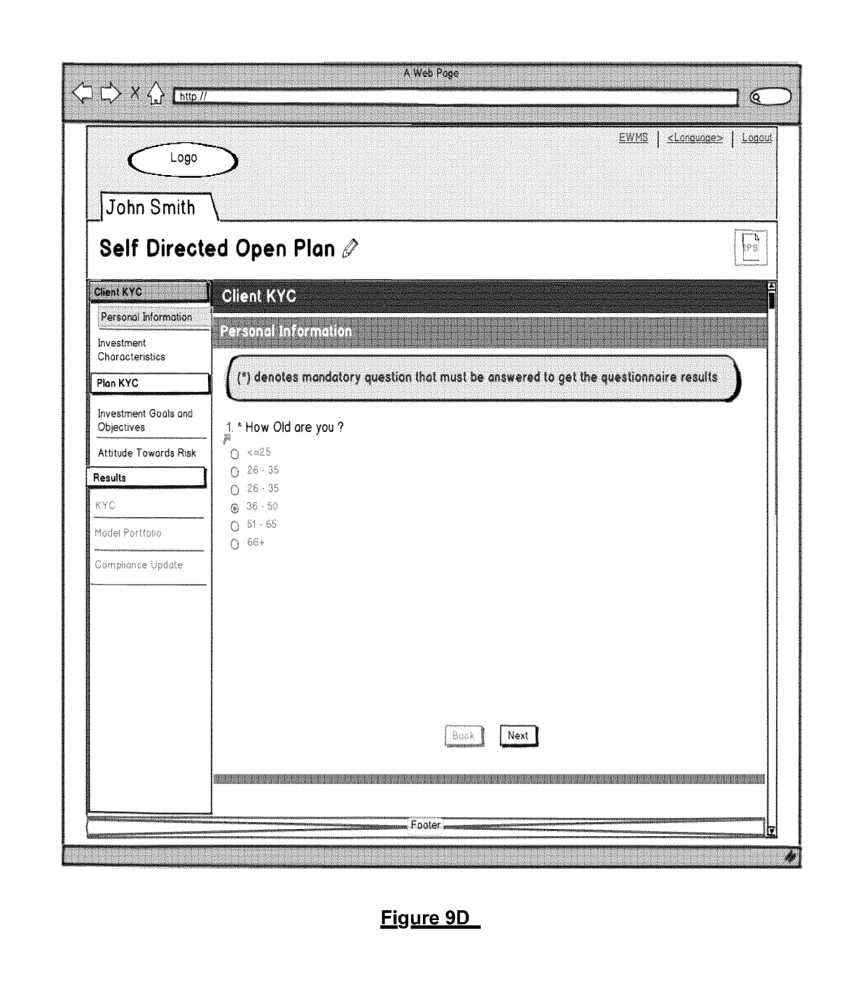

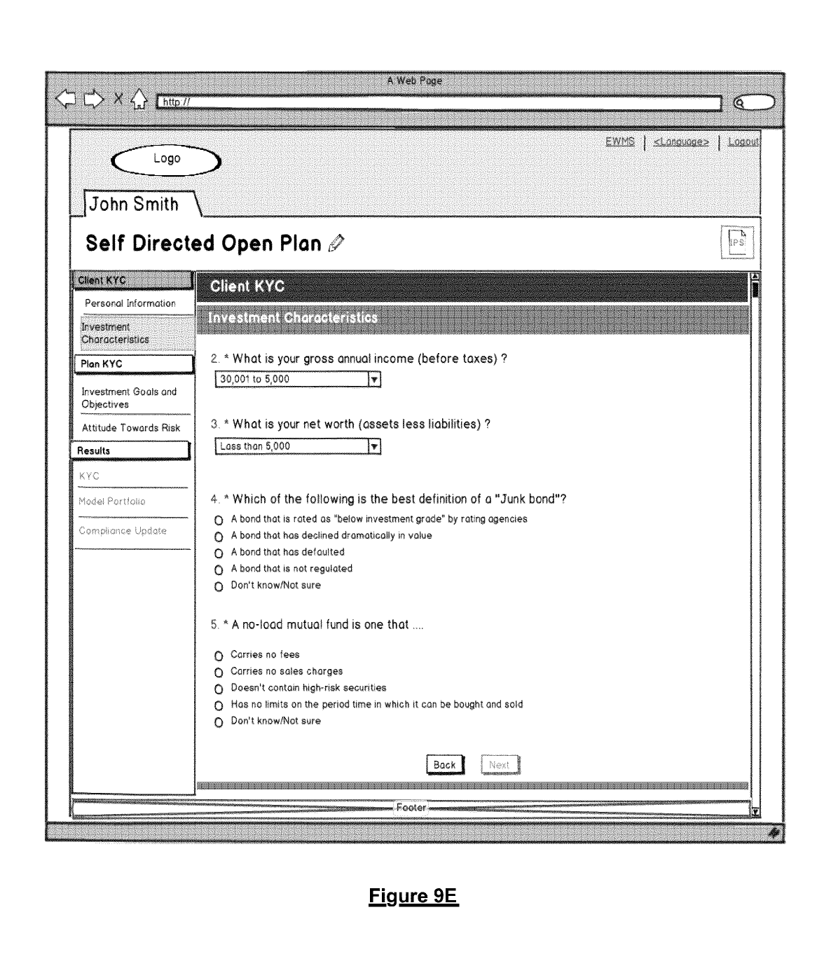

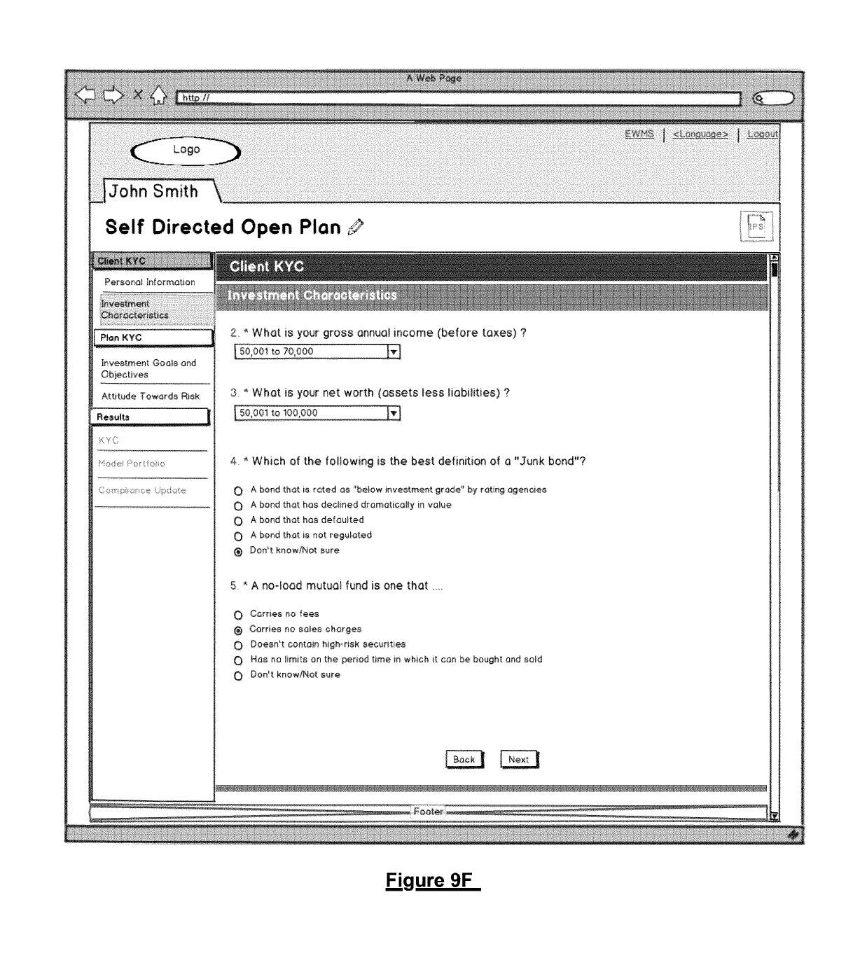

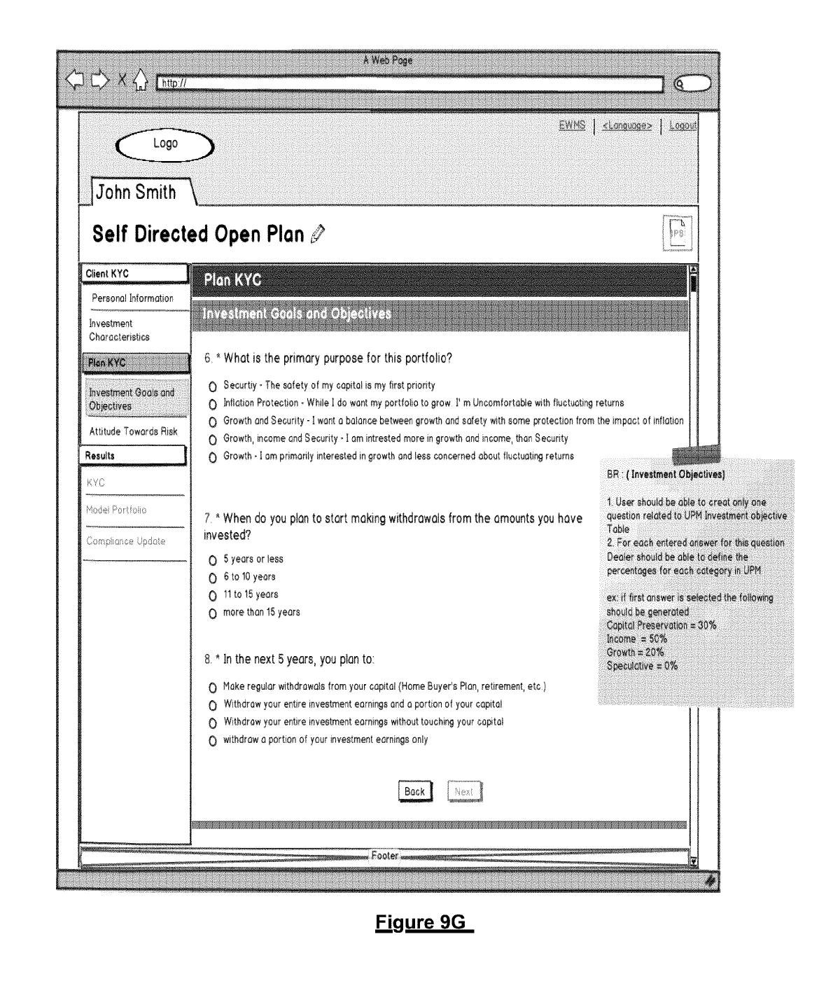

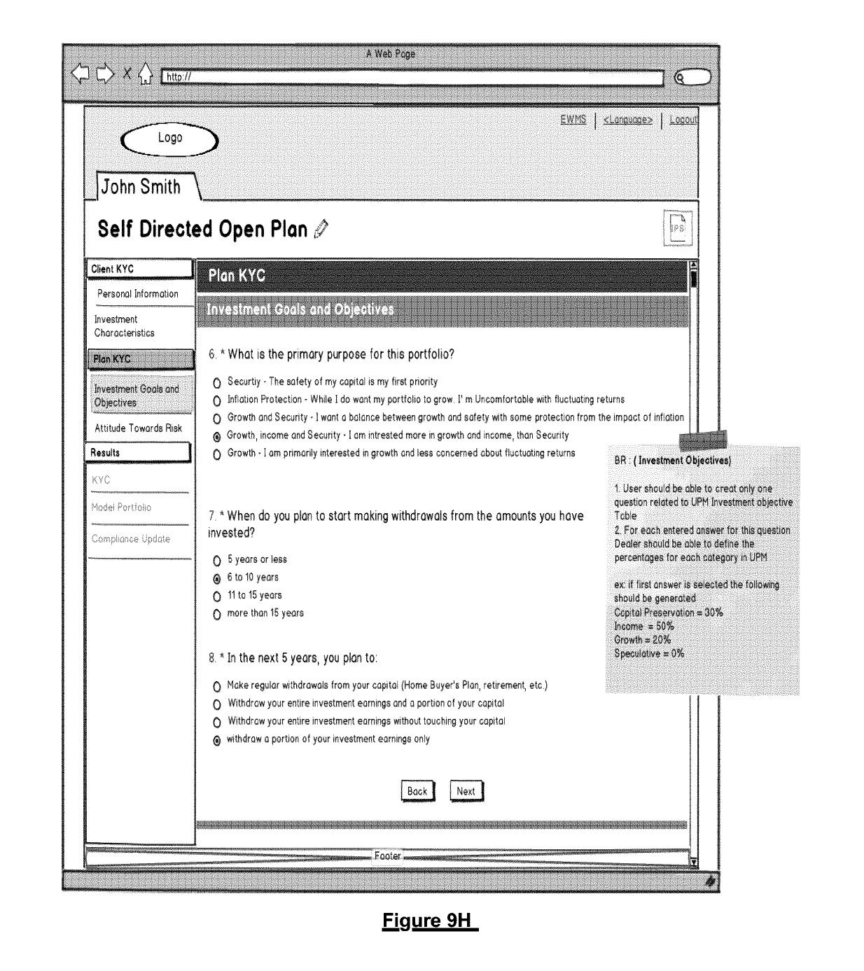

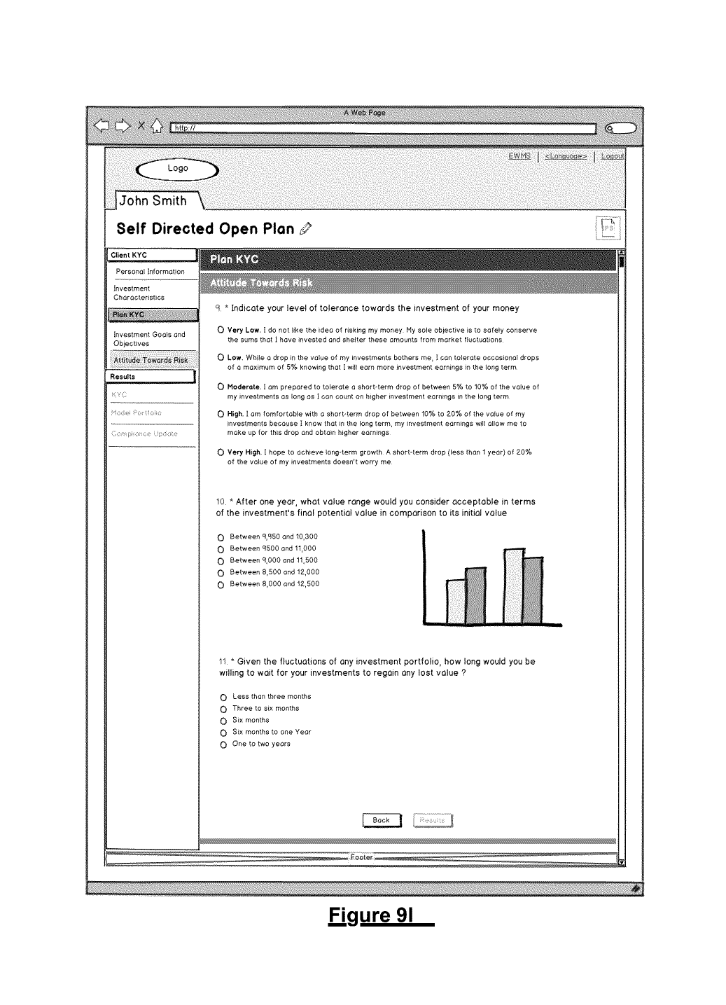

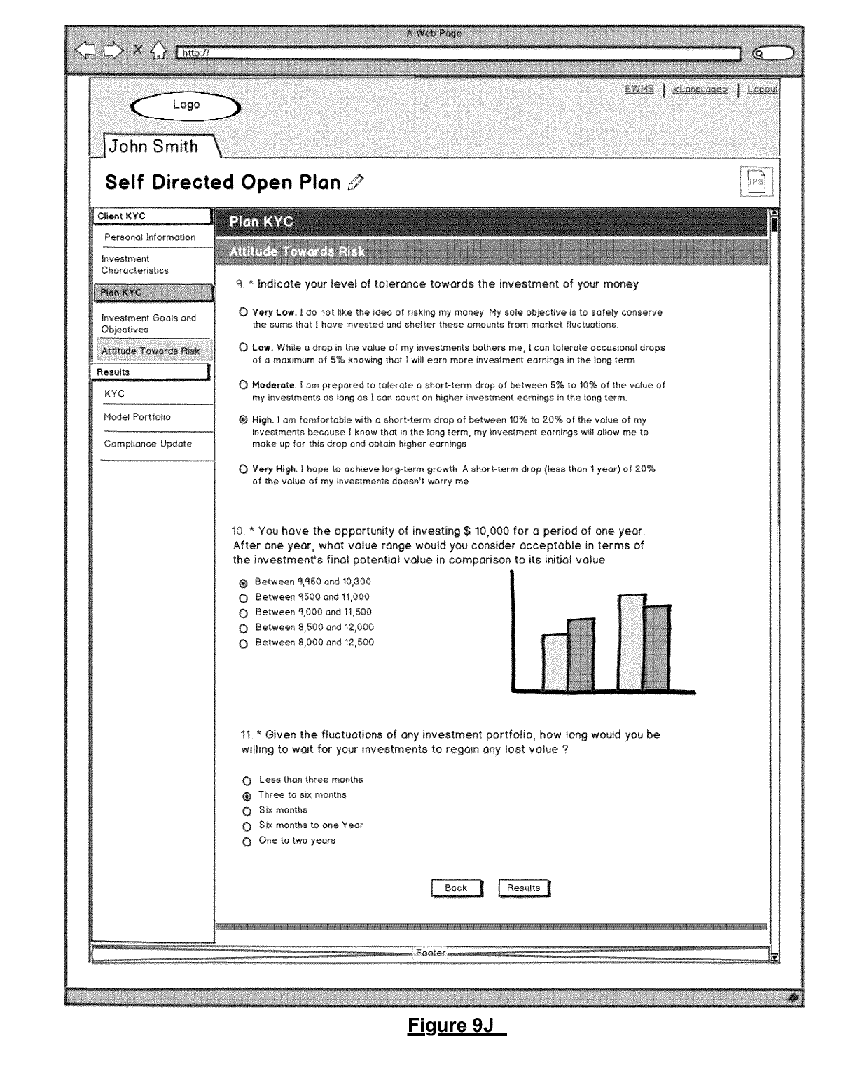

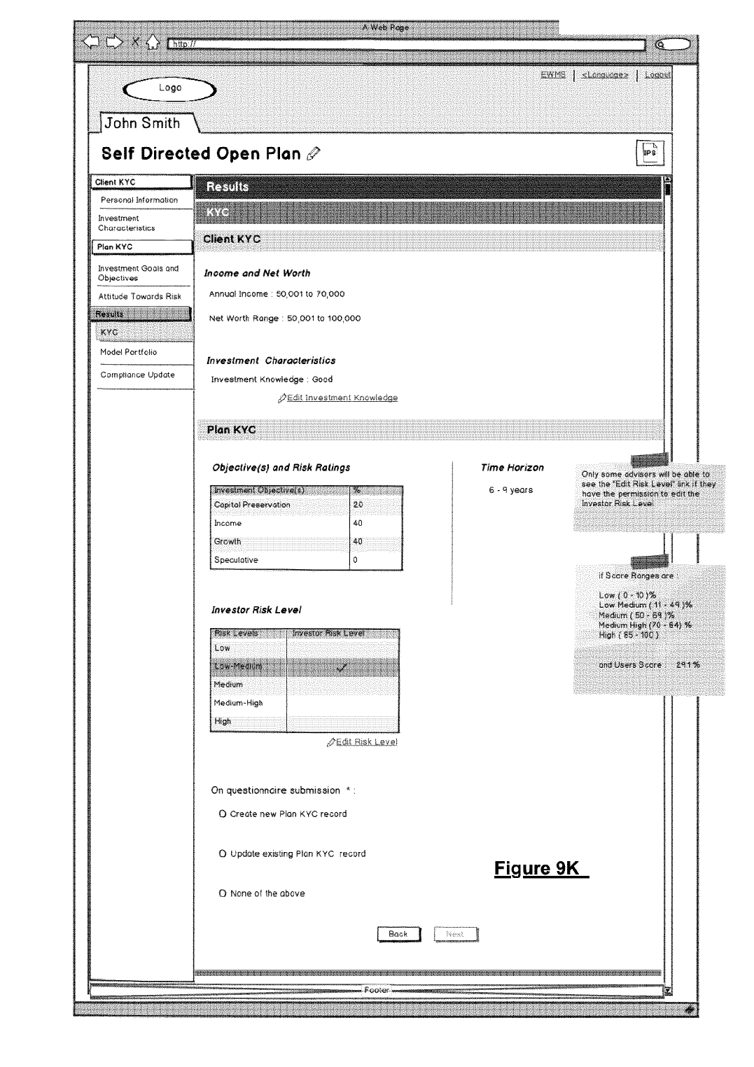

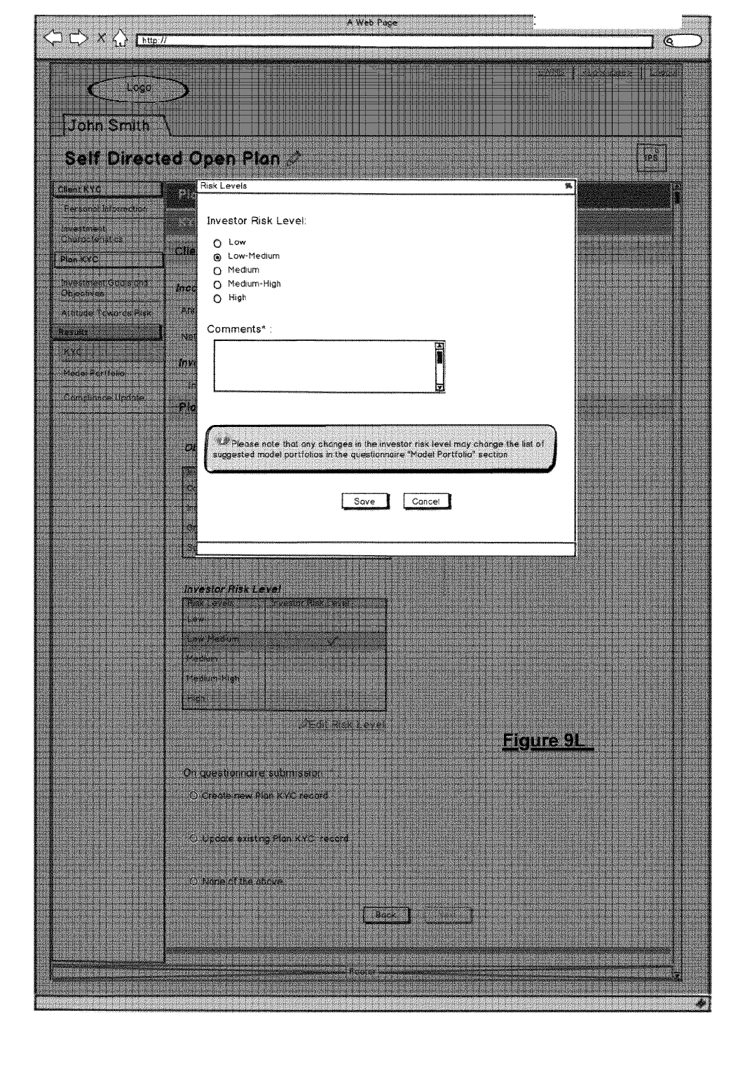

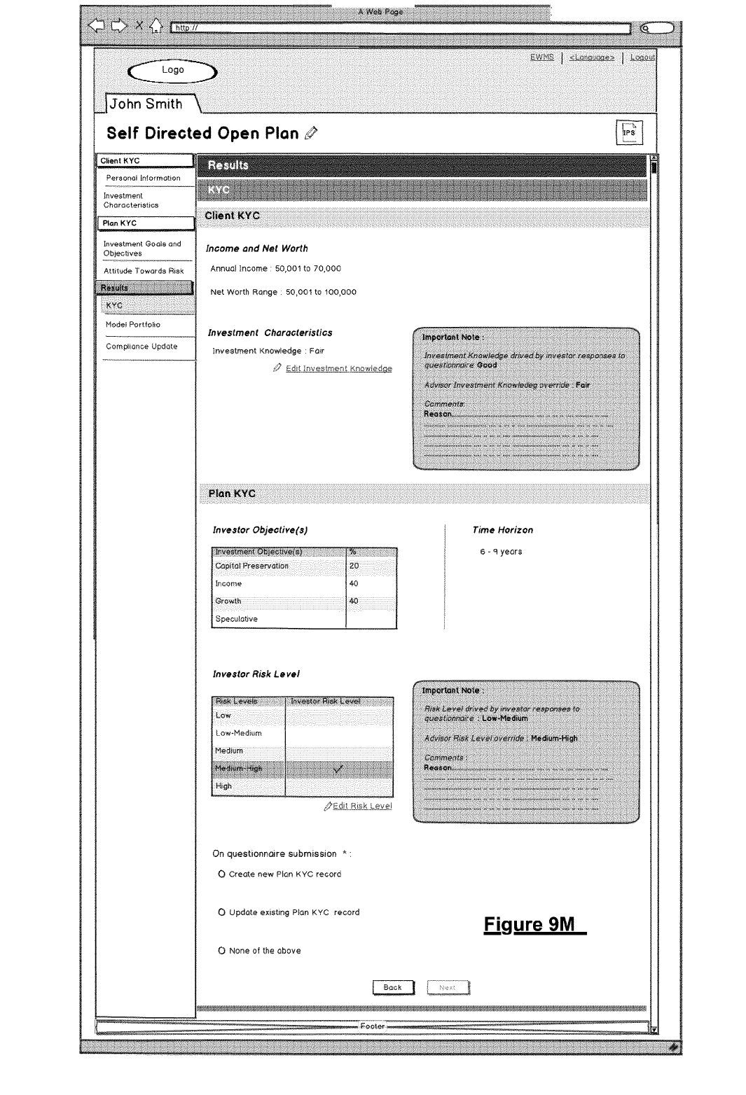

FIGS. 9A to 9M show various screens of a risk tolerance questionnaire designed using the computer system 20, in accordance with various aspects of the invention.

In FIG. 9A, a screen is shown where a client, identified as John Smith, requiring an updated RTQ to be completed. FIG. 9B shows the RTQs currently on file for each of the client's accounts, and in FIG. 9C, a new RTQ is being created with the title as shown. This initiates a series of questions as shown in FIGS. 9D-9J. FIG. 9K shows a results screen following completion of the questionnaire. An investor risk level must also be identified as per FIG. 9L. Finally, in FIG. 9M a results screen is shown that includes an identification of the client's risk level, along with a reason for arriving at that conclusion. The questionnaire may be used to create a new KYC record, or to update an existing KYC client record. A recommended model portfolio is output by the financial planning system of the invention. This process can be repeated for any number of accounts or clients. As this example shows, the RTQ and the KYC requirements are completed in a single step

Computer-executable instructions for implementing the financial planning application on a computer system could be provided separately from the computer system, for example, on a computer-readable medium (such as, for example, an optical disk, a hard disk, a USB drive or a media card) or by making them available for downloading over a communications network, such as the Internet.

While the computer system is shown as a single physical computer, it will be appreciated that the computer system can include two or more physical computers in communication with each other. Accordingly, while the embodiment shows the various components of the financial planning application residing on the same physical computer, those skilled in the art will appreciate that the components can reside on separate physical computers. One or more portions of the method may be executed by third parties.

While embodiments and examples of implementation have been herein described, the invention is not to be considered limited by the examples provided in the description. Rather, the scope of the invention is defined by the claims that follow.

We claim:

1. A computer implemented method for generating financial compliance data comprising:
generating by a computer system a risk tolerance questionnaire receiving data inputted by a user and stored in a first database on a computer readable medium in communication with the computer system; said risk tolerance questionnaire including data fields representative of a user's financial risk tolerance;
generating by the computer system a know-your-client user profile stored in a second database on a computer readable medium in communication with the computer system;
mapping one or more fields from said first database onto one or more fields from said second database, such that said know-your-client user profile is at least partially completed with data obtained from said risk tolerance questionnaire.

2. The method according to claim 1, wherein said risk tolerance questionnaire includes open-ended and close-ended questions; the method further including the step of periodically prompting a user to provide updated responses to said open-ended questions.

3. The method according to claim 1, further comprising determining by the computer system a financial portfolio recommendation for the user and presenting said financial portfolio recommendation to said user.

4. The method according to claim 1, wherein said know-you-client user profile includes data fields including one or more of client age, investment knowledge, income, net worth, financial objective, investment horizon and risk aversion.

5. The method according to claim 1, wherein said one or more fields mapped from said first database onto said second database include at least one score field; wherein said score field is stored on said second database and mapped from a field on said first database.

6. The method according to claim 1, further comprising storing said risk tolerance questionnaire in an archive database and subsequently creating a new risk tolerance questionnaire at least partially populated by said risk tolerance questionnaire in the archive database.

7. The method according to claim 1, further comprising providing by the computer system an alert to a user to update the risk tolerance questionnaire.

8. A system for generating financial compliance data comprising:
computer readable instructions stored on a computer readable medium that when executed by a computer system generates a risk tolerance questionnaire receiving data inputted by a user and stored in a first database on a computer readable medium in communication with the computer system; said risk tolerance questionnaire including data fields representative of a user's financial risk tolerance;
computer readable instructions stored on a computer readable medium that when executed by a computer system generates a know-your-client user profile stored in a second database on a computer readable medium in communication with the computer system;
computer readable instructions stored on a computer readable medium that when executed by a computer system maps one or more fields from said first database onto one or more fields from said second database, such that said know-your-client user profile is at least partially completed with data obtained from said risk tolerance questionnaire.

9. The system according to claim 8, wherein said risk tolerance questionnaire includes open-ended and close-ended questions; the method further including the step of periodically prompting a user to provide updated responses to said open-ended questions.

10. The system according to claim 8, further comprising instructions for determining by the computer system a financial portfolio recommendation for the user and presenting said financial portfolio recommendation to said user.

11. The system according to claim 8, wherein said know-you-client user profile includes data fields including one or more of client age, investment knowledge, income, net worth, financial objective, investment horizon and risk aversion.

12. The system according to claim 8, wherein said one or more fields mapped from said first database onto said second database include at least one score field; wherein said score field is stored on said second database and mapped from a field on said first database.

13. The system according to claim 8, further comprising instructions for storing said risk tolerance questionnaire in an archive database and subsequently creating a new risk tolerance questionnaire at least partially populated by said risk tolerance questionnaire in the archive database.

14. The system according to claim 8, further comprising instruction for providing by the computer system an alert to a user to update the risk tolerance questionnaire.
